(19) United States
(12) Patent Application Publication
(10) Pub. No.: US 2023/0302772 A1
(43) Pub. Date: Sep. 28, 2023

(54) AUTOMOTIVE LAMINATE WITH WEIGHT REDUCTION AND MECHANICAL STRENGTH ENHANCEMENT

(71) Applicant: AGP America S.A., Ciudad de Panama (PA)

(72) Inventors: Mario Arturo MANNHEIM ASTETE, Lima (PE); Massimo MICHETTI, Lima (PE); Gonzalo Rafael VIZCARRA MENDOZA, Lima (PE); Andres Fernando SARMIENTO SANTOS, Lima (PE); Raghu K. PENDYALA, Lima (PE); Vincenzo MANNINO, Lima (PE); Osmar CURI GRADOS, Lima (PE); Fabian VEGA, Lima (PE)

(21) Appl. No.: 18/041,653

(22) PCT Filed: Dec. 11, 2020
(86) PCT No.: PCT/IB2020/061792

§ 371 Date: Feb. 14, 2023

Related U.S. Application Data
(60) Provisional application No. 62/948,174, filed on Dec. 13, 2019.
(60) Provisional application No. 63/050,688, filed on Jul. 10, 2020.

(51) Int. Cl. B32B 17/10; B32B 7/02; B32B 17/06; F21V 8/00; B60J 1/00

(52) U.S. Cl. CPC B32B 17/10366; B32B 17/10036; B32B 7/02; B32B 17/061; B32B 17/10779; B32B 17/10752; B32B 17/10724; B32B 17/067; B32B 17/10045; B32B 17/10137; B32B 17/10174; B32B 17/10293; B32B 17/10541; G02B 6/0051; G02B 6/0068; B60J 1/001; B32B 2262/101; B32B 2262/106; B32B 2262/0261; B32B 2307/7376; B32B 2605/006; B60J 7/00

(57) ABSTRACT

In addition to providing for vision and protection from the external elements, various other features, such as lighting, cameras, sensors and displays have been integrated within automotive glazings Some of these require a laminate with an offset between the edges of at least two of the glass layers to accommodate components and/or connectors. When the edge of one glass layer is offset, such that it is no longer substantially captured by the mounting means used to install the glazing in the vehicle, the mechanical strength is reduced. To compensate, the remaining layer must be made stronger, usually by increasing the thickness. Even when compensated, the security of the glazing remains compromised as the smaller glass layer is not directly connected to the vehicle. If the larger glass layer should break, the opening may be left unprotected. By providing an innovative integrated reinforcement in the offset portion, a secure, stronger and lighter laminate can be obtained.

### ABSTRACT OF THE DISCLOSURE

In addition to providing for vision and protection from the external elements, various other features, such as lighting, cameras, sensors and displays have been integrated within automotive glazings. Some of these require a laminate with an offset between the edges of at least two of the glass layers to accommodate components and/or connectors. When the edge of one glass layer is offset, such that it is no longer substantially captured by the mounting means used to install the glazing in the vehicle, the mechanical strength is reduced. To compensate, the remaining layer must be made stronger, usually by increasing the thickness. Even when compensated, the security of the glazing remains compromised as the smaller glass layer is not directly connected to the vehicle. If the larger glass layer should break, the opening may be left unprotected. By providing an innovative integrated reinforcement in the offset portion, a secure, stronger and lighter laminate can be obtained.

### FIELD OF THE INVENTION

This invention relates to the field of laminated automotive glazing.

### BACKGROUND OF THE INVENTION

As automotive manufacturers work to meet government regulations for fuel efficiency and emissions, as well as to provide the environmentally friendly vehicles that the public is increasingly demanding, we are seeing the total glazed area of the vehicle increase. Part of the motivation is weight reduction. The increase in the glazed area tends to displace heavier materials used in vehicles. Another trend we see is towards a decrease in the average size of most vehicles as the manufacturers further work to reduce weight. As cabin volume decreases, it can lead to an unpleasant claustrophobic effect. To counter this, manufacturers have been increasing the glazed area of vehicles for several years. The expanded viewing area and increased incidence of natural light helps to give the cabin an offsetting more open and airier feel.

As a result of this trend, one glazing position in particular, the panoramic glass roof, has seen rapid growth over the last several years where it has become a popular option on new cars. A panoramic roof is a vehicle roof that is primarily comprised of glass and which covers a substantial portion of both the front and rear seating positions. The large panoramic glass roof gives the vehicle an airy and luxurious look. In recent years, the models offered with a panoramic roof option in North American and Europe represent 30 to 40% of the total number models available.

The roof may be comprised of a single large glazing or multiple adjacent glazings. The glazing may be fixed, movable or a combination of the two. Both tempered monolithic and laminated glass have been used. Monolithic tempered glass has the distinct disadvantage in that any failure is catastrophic. That is, the entire glass layer will break into small beads leaving the opening unprotected. This is why tempered glass is not allowed in the windshield position for example but may be allowed in other vehicle positions. However, one may see that a problem emerges when the vehicle glazing areas start to increase in size and the openings start to be considered a safety concern.

The utility of the increased glazed area has been further enhanced by means of integrating other types of technology and features with the glazing. Antennas are just one example. Antennas can be manufactured as an integral permanent part of the glazing by means of printed conductive silver, embedded wires in laminates and structured conductive coatings. A large percentage of rear windows are manufactured with complex antenna systems integrated with the defroster circuit. Other examples of integrated technology include touch control, occupant sensors, rain sensors, displays, variable light transmittance and lighting.

Some of the new features integrated with the glass are needed to replace components that were formerly mounted to the non-glazed surface that was eliminated. One of the challenges in vehicles with large glass roofs is cabin lighting. It is often not possible nor practical to mount a light near the center of the glass roof. Instead, auto makers have been placing lights above the doors, in the footwells, cup holders and at other locations. If a light is mounted on the glazing a wire cover is needed to hide the wires feeding the component.

In one innovative solution to this problem the glass is used to conduct light. Glass fibers have been used for many years in communications. The fibers conduct light by bouncing the light off the walls of the fiber. A flat or bent sheet of glass can be used in the same manner as a light guide. Light injected into an edge bounces off the two major surfaces of the glass sheet. The light is decoupled and exits the major surfaces at points where the surface is not reflective. Signs printed on a transparent substrate and illuminated by a light source injecting light into one of the edges have been known for decades. The printed graphic on the transparent light guide substrate disperses the light inside of the glass illuminating the graphic. The information on a sign is intended to be viewable under all lighting conditions. The illumination is only to allow the sign to be seen under low lighting conditions. The same approach can be used for general illumination, but a light dispersing layer is still needed. If the light dispersing layer is visible when the device is in the off state, the substrate can no longer serve also as a window.

Edge injection of light into the glass can be used to provide cabin illumination. In this method, the glass functions as a wave guide for the light injected along the edges. The light is decoupled and refracted by light dispersing means on the glass surface. Light dispersing materials are known that when applied to glass are substantially invisible when the lighting means is in the off state while providing bright illumination in the on state.

The most effective way of producing such an illuminated glazing is through means of a laminate. The inner glass layer is illuminated by a lighting means along at least a portion of the periphery of the glazing with the dispersing means deposited on the inner glass layer face interior to the laminate, thereby protecting the dispersing means from damage. Coatings can be applied to the outer glass layers to further improve performance, reflecting incidental light from the dispersing means inboard. An opaque layer, such as a black frit, may also be used to block light from exiting to the exterior of the vehicle.

The edge of the inner glass layer must be offset inboard from the edge of the outer glass layer along at least a portion of the periphery in order to facilitate the mounting of the lighting means. This configuration is illustrated in the cross-section shown in FIG. 4A. An array of LEDs comprising a light bar, is typically used and mounted to the outer glass layer 201 in the exposed area where the two glass layer edges are offset 32 from each other. The light is injected into the edge of the inner glass layer 202.

The roof glazing is bonded directly to the vehicle or to an assembly which is then mounted to the vehicle. Whether directly bonded to the vehicle or an assembly, encapsulated in a molding, wrapped in a lace or otherwise secured, these shall all be considered as equivalent and referred to as the mounting means. The area near the edge of glass is used to secure the laminate to the mounting means. Due to the offset of the inner glass, typically of at least 20 mm, the inner glass layer is often not in full contact with the mounting means along its entire periphery. This offset portion does not provide any strength or support for the glazing. The outer glass layer must have sufficient strength on its own to support the glazing. This prevents the use of the typical annealed windshield thickness glass layer for the outer glass layer of the laminate. Such an annealed layer would have a high probability of breakage under normal use and poor retention.

The probability of breakage is even more of a problem in the event of an accident. Regulatory requirement mandate that the glazing must pass a number of tests which include but are not limited to: roof crush, push out, torsion and rollover which may be difficult to pass with such a glazing.

When a laminate with a technology requiring an offset is needed, it is typical to use a thicker tempered glass for the outer glass layer such as an outer glass layer 3.2 mm thick. This compares to a typical annealed laminate with a 2.1 mm outer glass layer which would be enough if it did not have an offset.

While a reduction of ˜1 mm may not appear to be that great of a savings, on a one square meter roof, a 1 mm reduction in thickness corresponds to a 2.6 kg reduction in weight. In an industry where a reduction of 2.6 grams is considered a breakthrough, 2.6 kg would be of great value.

Another approach has been to use three glass layers. Two of the layers extend to the edge, providing the required strength, and the third layer is offset. This adds to the weight and thickness of the glazing and therefore cannot be considered as a satisfactory solution.

An edge offset is desirable for weight reduction even when not required by other technologies. As an example, laminate with an area of one square meter, a 25 mm offset and a 2.1 mm thick soda-lime inner 202 glass layers will have a reduction in weight of 135 grams. Performance films and interlayers need not extend to the edge of the laminate to provide the intended added functionality. Solar control products are of little value outside of the daylight opening. Sound dampening interlayers do little in the portions of the glazing already dampened by the interior trim. Another issue is breakage. The plastic interlayer of the laminate will hold the broken pieces of the laminate together and the mounting means will hold the failed glazing in place helping to protect the occupants. The vehicle can still be operated. However, if the entire periphery of the laminate is not captured by the mounting means, due to the offset, the opening can be left without protection. Breakage is even more of a problem when tempered glass is used for the outer glass as the entire layer will shatter breaking into small beads with little structural integrity.

LED lighting is being used more and more in automotive applications. From ambient lighting to headlamps, the cost, reliability and intensity or LEDs has reached the point where it is a cost-effective replacement for incandescent and other resistive lighting technologies. Indeed, with a lifetime as long as 50,000 hours, the LEDs may well last much longer than the vehicle.

An issue arises when embedding LEDs into a laminate. The rated lifetime of an LED must be substantially de-rated when used in an automotive application due to the harsh environmental demands of the application as well as the required product life. Automotive components are subjected to extremes of temperature, vibration and shock and an automobile will be in service far longer than the warranted life of an LED. Thermal management is also an issue as it may not be possible to have the optimum air circulation around an LED that is embedded in an assembly.

Likewise, the mean time between failures (MTBF), while high, must also be de-rated. To get the MTBF for the system we must divide the de-rated MTBF of a single LED by the total number of LEDs. A one square meter roof may require 100 or more LEDs. In this case, the MTBF for the system, that is the expected time to failure for one LED is the MTBF divided by 100.

Even if the LED does not fail, LEDs have a limited lifetime. Performance degrades with time and the level of light emitted decreases. The rated lifetime of an LED is generally given as the number of hours that it will take for the output to drop to 70% of its initial brightness.

Efforts to embed LEDs in laminated glass have met with mixed results. One of the main issues is the high intensity of LEDs intended for general illumination. Due to the small size of the LED die and the difficulty of including any kind of a lens or diffuser in a laminate, the light intensity of the die tends to be very high. This can make night driving difficult for the driver.

As a result, optimal integration of the LEDs has not been possible.

In the case of the light bar used to edge illuminate a panoramic roof, the light bar is a separate component which is attached to the laminate such that it can be replaced without having to remove or replace the glazing. The interior trim and other parts of the vehicle must also be designed as to facilitate access to the lighting means. This adds to the cost and complexity of the glazing and the roof.

Redundancy has long been the means used to improve the reliability of critical systems. In many industries, critical components must have double or even triple redundancy in order to meet safety regulations. Due to the higher initial cost and less that critical nature of most automotive components, as well as design obsolescence, this has not been a standard practice. While the use of LED lighting has been increasing, for signaling and illumination, designs usually make use of lenses and diffusers to make the loss of one or more LEDs less than obvious. The points of light that sometimes appear to be LEDs are often not individual LEDs but rather light that has been diffused, reflected and focused by a molded lens.

A solution to these problems, that could provide for increased strength and security of the glazing would be of great value.

### BRIEF SUMMARY OF THE INVENTION

The area of the laminate where the outer 201 and inner glass 202 layers are offset 32 is reinforced by bonding a reinforcing material 22 to the glazing. The reinforcement 22 overlaps at least a portion of the exposed outer glass layer 201 or at least a portion of both the exposed outer glass layer 201 and the inner glass layer 202. The inboard side of the reinforcement 22, if any, is embedded between the two glass layers providing for a strong mechanical linkage to the mounting means. The remainder of the reinforcement 22 is bonded to the otherwise exposed outer glass layer 201 number two surface 102 and extends sufficiently outboard such that it is securely captured by the mounting means. In this manner the strength of the laminate is increased allowing for the use of thin annealed glass for the outer glass layer 201. Likewise, the security of the glazing is greatly improved regardless of whether the glass is annealed, partially tempered (semi-tempered) or fully tempered.

The offset provides a convenient area where various types of components can be mounted to without adding to the size or volume of the glazing. In several embodiments, lighting means is added with minimal or no increase in the thickness of the glazing. The offset also provided protection for the components. Additional value-added components may also be added as required.

The reinforcement also provides added strength for any encapsulation which may be applied over it. The reinforcement will enhance the bond of the encapsulation by means of their larger surface area and/or higher surface tension. The mechanical performance and stability of an encapsulated offset edge is improved by the reinforcement.

The reinforcement can be added without modifying the standard glass lamination process. In practical means, just one additional step is required during the assembly of the layers which is the insertion of the reinforcement in the laminate.

In some embodiments, a lighting means (light bar) 26 is permanently attached to the glazing. This is possible due to the redundant design used to extend the lifetime of the lighting means 26. The lighting means 26 is comprised of at least two independent set of LEDs 28. The first set 40 serves as the primary set and initial light source and the at least second set 42 serves as a backup light source (See FIG. 12). In the event of a failure in the primary set, the backup set can be activated. The primary and backup sets may be divided into smaller groups to improve reliability further. Each group can be independently turned on or off by the switching means 44. Detection and switching may be accomplished through a variety of means including but not limited to monitoring of the current flow or voltage drop across the LEDs 28. In this manner failures may be detected, and the backup group automatically switched. Alternately, the LEDs 28 can be manually switched by means of an interface 46. Another option is to use a light detector to measure the output of the LEDs 28 and automatically adjust the groups accordingly.

The light bar 26 can be bonded to the glazing over the reinforcement 22 (see FIGS. 10A and 10B) or the light bar 26 can be bonded to the glazing with the reinforcement 22 bonded to the light bar 26 in addition to the two glass layers (see FIGS. 11A and 11B).

In some embodiments, a stiffening support 30 is added so as to add stiffness and support and in doing so also improve retention of the glazing in the opening in the event of breakage.

### ADVANTAGES

Lighter weight
Stronger
Improved occupant retention
Improved regulatory compliance
Severity of failure reduced
High strength
Reduced cost
Protection for lighting means provided by offset
Higher mechanical stability
No change to standard lamination process
Heat sink for active electrical components
Improved adhesive to components
Lower part count
Lower complexity
Lighting means designed to last the lifetime of vehicle
Permanent or replaceable lighting means is possible with no physical change
Improved retention of the glazing in the opening in the event of breakage

### BRIEF DESCRIPTION OF THE SEVERAL VIEWS OF THE DRAWINGS

FIG. 1A shows a cross section: typical laminated automotive glazing.

FIG. 1B shows a cross section: typical laminated automotive glazing with performance film and coating.

FIG. 1C shows a cross section: typical tempered monolithic automotive glazing.

FIG. 2 shows an exploded view of a laminated roof.

FIG. 3 shows a bottom view of a laminated roof.

FIG. 4A shows a cross Section AA: Prior art.

FIG. 4B shows a cross Section AA: reinforcement bonded by means of a slit made in a single interlayer.

FIG. 5A shows a cross Section AA: reinforcement bonded by adhesive and plastic interlayer.

FIG. 5B shows a cross Section AA: thermoplastic reinforcement bonded by itself and plastic interlayer.

FIG. 6A shows a cross Section AA: reinforcement bonded between two plastic interlayers.

FIG. 6B shows a cross Section AA: reinforcement with encapsulation and lighting means.

FIG. 6C shows a cross Section AA: reinforcement with a stiffening support.

FIG. 7 shows an exploded view of a laminated panoramic roof with: the PVB interlayer 4 extending to the edge of the outer glass layer 201, the reinforcement 22 bonded to the outer glass layer 201 by means of the PVB 4, the inner glass layer 202 bonded to the reinforcement 22 by means of an adhesive 34 and the light bar 26 bonded to the reinforcement 22. The encapsulation is not shown.

FIG. 8 shows an exploded view of a laminated panoramic roof with: the PVB interlayer 4 extending to the edge of the inner glass layer 202, the reinforcement 22 bonded to the outer glass layer 201 by means of an adhesive 34, the inner glass layer 202 bonded directly to the reinforcement 22 by means of an adhesive 34 and the light bar 26 bonded to the reinforcement 22. The encapsulation is not shown.

FIG. 9 shows an exploded view of a laminated panoramic roof with: the PVB interlayer 4 extending to the edge of the inner glass layer 202, the light bar bonded to the outer glass layer 201 by means of an adhesive 34, the reinforcement 22 bonded over the light bar 26 and to the inner 202 and outer 201 glass layers by means of an adhesive 34. The encapsulation is not shown.

FIG. 10A shows cross section AA: with a plastic interlayer 4 extending to edge of outer glass layer 201 used to bond the reinforcement 22 to the outer glass layer 201. The reinforcement 22 is bonded to the inner glass layer 202 by means of an adhesive 34. The light bar 26 is bonded to the reinforcement 22 by means of an adhesive 34. The glazing is encapsulated with injected molded thermoplastic.

FIG. 10B shows cross section AA: with a first plastic interlayer 4 extending to edge of outer glass layer 201 used to bond the reinforcement 22 to the outer glass layer 201. The reinforcement 22 is placed between the first plastic interlayer 4 and a second plastic interlayer 4 which bonds the reinforcement 22 to the inner glass layer 202. The light bar 26 is bonded to the reinforcement 22 by means of an adhesive 34. The glazing is encapsulated with injected molded thermoplastic.

FIG. 10C shows cross section AA: with plastic interlayer 4 extending to edge of outer glass layer 201 used to bond the reinforcement 22 to the outer glass layer 201. The reinforcement 22 is bonded to the outer glass layer 201 in that area where the two glass layers 201, 202 do not overlap, the offset portion 32. The light bar 26 is bonded to the reinforcement 22 by means of an adhesive 34. The glazing is encapsulated with injected molded thermoplastic.

FIG. 11A shows cross section AA: with a plastic interlayer 4 extending to edge of inner glass layer 202. The light bar 26 is bonded to the exposed number two surface 102 of the outer glass layer 201 in the offset portion by means of an adhesive 34. The reinforcement 22 is bonded to the number four surface 104 of the inner glass layer 202, to the light bar 26 and to the exposed portion of the number two surface 102 of the outer glass layer 201 by means of the adhesive 34. The glazing is encapsulated with injected molded thermoplastic.

FIG. 11B shows cross section AA: with a plastic interlayer 4 extending to edge of outer glass 201, the light bar 26 is bonded to the exposed plastic interlayer 4 in the offset portion by means of an adhesive 34. The reinforcement 22 is bonded to the number four surface 104 of the inner glass layer 202, to the light bar 26 and to the exposed plastic interlayer 4 by means of the adhesive 34. The glazing is encapsulated with injected molded thermoplastic.

FIG. 12 shows a typical light bar circuit. The LEDS 28 are grouped in sets of 4 to a control circuit 44. Each primary set 40 has a backup set 42.

### DETAILED DESCRIPTION OF THE INVENTION

The following terminology is used to describe the laminated glazing of the invention.

The term “glass” can be applied to many organic and inorganic materials, including many that are not transparent. For this document we will only be referring to non-organic transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Laminates, in general, are articles comprised of multiple sheets of thin, relative to their length and width, material, with each thin sheet having two oppositely disposed major faces and typically of relatively uniform thickness, which are permanently bonded to each other across at least one major face of each sheet.

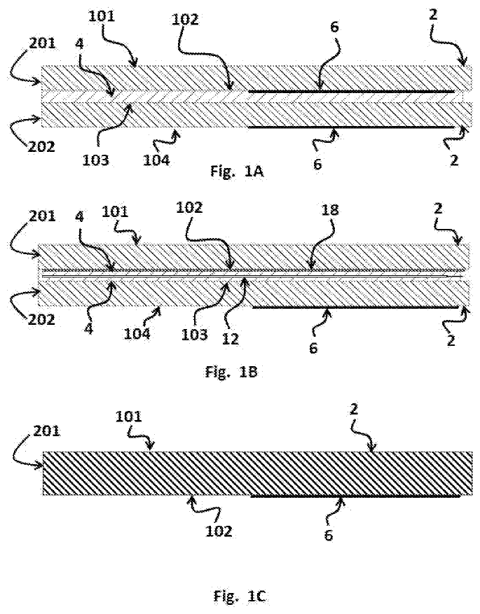

Laminated safety glass is made by bonding two sheets (201 & 202) of annealed glass 2 together using a plastic bonding layer comprised of a thin sheet of transparent thermoplastic 4 (interlayer) as shown in FIGS. 1A and 1B.

Laminated annealed glass is required for windshields. The laminate of the invention may be comprised of annealed, partially tempered and fully tempered glass layers.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic bonding layer also helps to prevent penetration by objects striking the laminate from the exterior and in the event of a crash occupant retention is improved. Typical automotive laminated glazing cross sections are illustrated in FIGS. 1A and 1B. A laminate is comprised of two layers of glass, the exterior or outer layer 201 and the interior or inner layer 202 that are permanently bonded together by a plastic bonding layer 4 (interlayer). In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic bonding layer 4. An obscuration 6 may be also applied to the glass. Obscurations are commonly comprised of black enamel frit printed on either the number two 102 or number four surface 104 or on both. The laminate may have a coating 18 on one or more of the surfaces. The laminate may also comprise a film 12 laminated between at least two plastic bonding layers 4.

FIG. 1C shows a typical tempered automotive glazing cross section. Tempered glazing is typically comprised of a single layer of glass 201 which has been heat strengthened. The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass. Obscurations are commonly comprised of black enamel frit printed on the surface two 102. The glazing may have a coating 18 on the surface one 101 and/or surface two 102 (not shown).

The plastic bonding layer 4 (interlayer) has the primary function of bonding the major faces of adjacent layers to each other. The material selected is typically a clear thermoset plastic.

For automotive use, the most commonly used plastic bonding layer 4 (interlayer) is polyvinyl butyral (PVB). PVB has excellent adhesion to glass and is optically clear once laminated. It is produced by the reaction between polyvinyl alcohol and n-butyraldehyde. It is important to recognize that PVB by itself it is too brittle. Plasticizers must be added to make the material flexible and to give it the ability to dissipate energy over a wide range of temperature which an automobile is subjected to. Only a small number of plasticizers are used. They are typically linear dicarboxylic esters, where the two most common ones are di-n-hexyl adipate and tetra-ethylene glycol di-n-heptanoate. A typical automotive PVB interlayer is comprised of 30-40% plasticizer by weight.

In addition to polyvinyl butyl, ionoplast polymers, ethylene vinyl acetate (EVA), cast in place (CIP) liquid resin and thermoplastic polyurethane (TPU) can also be used. Automotive interlayers are made by an extrusion process which has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil).

Interlayers are available with enhanced capabilities beyond bonding the glass layers together. The invention may include interlayers designed to dampen sound. Such interlayers are comprised whole or in part of a layer of plastic that is softer and more flexible than that normally used. The interlayer may also be of a type which has solar attenuating properties.

A wide variety of films are available that can be incorporated into a laminate. The uses for these films include but are not limited to: solar control, variable light transmission, increased stiffness, increased structural integrity, improved penetration resistance, improved occupant retention, providing a barrier, tint, providing a sunshade, color correction, and as a substrate for functional and aesthetic graphics. The term “film” shall include these as well as other products that may be developed or which are currently available which enhance the performance, function, aesthetics or cost of a laminated glazing. Most films do not have adhesive properties. To incorporate into a laminate, sheets of plastic interlayer are needed on each side of the film to bond the film to the other layers of the laminate.

Infrared reflecting coatings 18 (FIG. 1A) include but are not limited to the various metal/dielectric layered coatings applied through Magnetron Sputtered Vacuum Deposition (MSVD) as well as others known in the art that are applied via pyrolytic, spray, controlled vapor deposition (CVD), dip and other methods.

To control the level of light transmission through the laminate, there are many technologies available: electrochromic, photochromic, thermochromic and electric field sensitive films which are designed to be incorporated into laminated glass. Other interesting technologies used are known as the suspended particle device (SPD) films and polymer dispensed liquid crystal (PDLC) films which can quickly change their light transmittance in response to an electrical field.

The glass layers are formed using gravity bending, press bending, cold bending or any other conventional means known in the art. In the gravity bending process, the flat glass is supported near the edge of glass and then heated. The hot glass sags to the desired shape under the force of gravity. With press bending, the flat glass is heated and then bent on a full of partial surface mold. Air pressure and vacuum are often used to assist the bending process. Gravity and press bending methods for forming glass are well known in the art and will not be discussed in detail in the present disclosure.

Cold bending is a relatively new technology. As the name suggest, the glass is bent, while cold to its final shape, without the use of heat. On parts with minimal curvature a flat sheet of glass can be bent cold to the contour of the part. This is possible because as the thickness of glass decreases, the sheets become increasingly more flexible and can be bent without inducing stress levels high enough to significantly increase the long-term probability of breakage. Thin sheets of annealed soda-lime glass, in thicknesses of about 1 mm, can be bent to large radii cylindrical shapes (greater than 6 m). When the glass is chemically, or heat strengthened the glass can endure much higher levels of stress and can be bent along both major axes. The process is primarily used to bend chemically tempered thin glass sheets (<=1 mm) to shape.

Cylindrical shapes can be formed with a radius in one direction of less than 4 meters. Shapes with compound bend, that is curvature in the direction of both principal axes can be formed with a radius of curvature in each direction of as small as approximately 8 meters. Of course, much depends upon the surface area of the parts and the types and thicknesses of the substrates.

The cold bent glass will remain in tension and tend to distort the shape of the bent layer that is bonded to. Therefore, the bent layer must be compensated to offset the tension. For more complex shapes with a high level of curvature, the flat glass may need to be partially thermally bent prior to cold bending.

The glass to be cold bent is placed with a bent to shape layer and with a bonding layer placed between the glass to be cold bent and the bent glass layer. The assembly is placed in what is known as a vacuum bag. The vacuum bag is an airtight set of plastic sheets, enclosing the assembly and bonded together to the edges, which allows for the air to be evacuated from the assembly and which also applies pressure on the assembly forcing the layers into contact. The assembly, in the evacuated vacuum bag, is then heated to seal the assembly. The assembly is next placed into an autoclave which heats the assembly and applies high pressure. This completes the cold bending process as the flat glass at this point has conformed to the shape of the bent layer and is permanently affixed. The cold bending process is very similar to a standard vacuum bag/autoclave process, well known in the art, except for having an unbent glass layer added to the stack of glass.

The glass layers may be annealed or strengthened. There are two processes that can be used to increase the strength of glass. They are thermal strengthening, in which the hot glass is rapidly cooled (quenched) and chemical tempering which achieves the same effect through an ion exchange chemical treatment.

Heat strengthened, fully temper soda-lime float glass, with a compressive strength in the range of at least 70 MPa, can be used in all vehicle positions other than the windshield. Heat strengthened (tempered) glass has a layer of high compression on the outside surfaces of the glass, balanced by tension on the inside of the glass which is produced by the rapid cooling of the hot softened glass. When tempered glass breaks, the tension and compression are no longer in balance and the glass breaks into small beads with dull edges. Tempered glass is much stronger than annealed laminated glass. The minimum thickness of the typical automotive heat strengthening process is in the 2.6 mm to 3.0 mm range. This is due to the rapid heat transfer that is required. It is not possible to achieve the high surface compression needed with thinner glass using the typical blower type low pressure air quenching systems.

In the chemical tempering process, ions in and near the outside surface of the glass are exchanged with ions in the chemical bath that are larger. This places the outer layer of glass in compression. Compressive strengths of up to 1, 000 MPa are possible. The typical method involves submerging the glass in a tank of molten salt where the ion exchange takes place. The glass surface must not have any paint or coatings that will interfere with the ion exchange process.

Anything to be laminated between the two glass layers must have a maximum thickness of no more than the thickness of all the plastic interlayers. As a general rule, to laminate without modification of the interlayer, the object must be no more than one third of the total thickness of the plastic interlayers. If the insert is too thick, a portion of the plastic must be removed, or a thicker or additional plastic layer must be added to compensate the difference in thickness. During the lamination process, the laminate is treated with heat and pressure. At higher temperatures and pressures, the plastic interlayer will melt and flow to accommodate the thickness of the insert. The type of interlayer and thickness, the type and thickness of the glass, the composition and shape of the object, the shape of the part and other variables are all factors.

A number of materials can be used as a reinforcement. The primary requirements are strength, compatibility with the lamination process and that they be able to survive in an automotive environment without degradation for the lifetime of the vehicle. Stiffness is desirable but not required.

Thin metal mesh is one type of reinforcement that has proven effective even though it contributes very little to the stiffness of the laminate. The mesh conforms to the curvature of the glass surface and the textured surface of the mesh provides a large effective surface area enhancing the strength of the bond to the glass layers. In addition to its high strength, it is impervious to the elements and will outlast the vehicle. Stainless-steel mesh with a thickness in the range of 0.3 mm to 0.7 mm has been tested and found to work with 0.76 mm PVB. As the PVB will flow and fill the voids between the fiber of the mesh, we can successfully laminate a thicker mesh than would be possible with a solid material.

Metal meshes have the added advantage in that they are much more thermally conductive than the glass or plastic. When used in conjunction with a lighting means, such as an LED light bar, the mesh acts as a heat sink.

CPET has also been proven effective. It too is very strong and has the additional benefit of not requiring an adhesive to bond to the glass. CPET is a thermoplastic that will bond to the glass at standard autoclave and glass laminating process temperatures.

Non-oriented multi-layer polyester cast PET (CPET) film is produced by extrusion of amorphous polyethylene terephthalate. CPET has a number of properties that make it well suited for this application. The film has high surface tension which facilitates a strong bond to PVB and other materials. The film can be formed and welded at glass lamination process temperatures. CPET film is widely available from many suppliers as it is used worldwide for printing, welding, laminating, gluing and thermoforming. Most of us have had firsthand experience trying to overcome the strength of CPET while opening a product packaged in a clear CPET molded pack. CPET with a thickness in the range of 0.05 mm to 0.4 mm has been tested and found to work with 0.76 mm PVB. At processing temperatures, the CPET softens and becomes tacky, bonding to the adjacent surfaces. It will also become viscous and flow allowing for the use of a thickness that would be otherwise impossible.

Aramid fiber cloth, with a thickness in the range of 0.05 mm to 0.4 mm has been tested and found to work with 0.76 mm PVB. Other materials such as metal sheet (including metal alloys), PET, polyimide, polyamide, polycarbonate (PC), carbon fiber cloth and fiberglass cloth can be also used.

Chemically tempered alumina-silicate glass can also be used. The thickness must be less than that of the interlayer, preferably, less than ⅓ of the thickness of the interlayer. If the thickness is close to that of the interlayer, then the PVB interlayer must be cut back and a separate adhesive must be used to bond the reinforcement to the glass. A spacer and additional layers of interlayer are not required.

As previous mentioned, the outer glass layer can be annealed, partially tempered or fully tempered. In some embodiments, wherein the mechanical performance is preferred over the weight savings, the thickness of the outer glass layer 201 may be as much as 5 mm. However, in another embodiments, the thicker tempered outer glass layer 201 can be replaced by a thinner annealed glass layer. The inner glass layer 202 can be of the same thickness that would ordinarily be used for a standard laminated and annealed windshield such as 2.1 mm. Likewise, standard 0.38 mm and/or 0.76 mm thick PVB plastic interlayer is all that is needed. The laminate may also comprise embedded wires, variable transmittance films such as SPD and PDLC as well as performance coatings, films and interlayers.

Most standard windshield cross sections can be used when producing the invention including but not limited to those comprising thin chemically tempered glass layers and cold bent inner layers.

Note that the reinforcement 22 may be comprised of several segments and that all need not be the same material. Different materials may be used as appropriate for the application and technology.

Another advantage of the reinforcement is retention of the glazing in the event of breakage that is significantly improved beyond that of a typical laminate in the event of breakage. It is even more the case when the reinforcement extends from inboard of the inner glass layer into the path of the polyurethane adhesive used to bond the glazing to the body.

In several embodiments, lighting means (light bar) 26 is attached to the glazing in the offset portion 32 of the outer glass layer 201. The lighting means 26 may be permanently attached to the glazing. A large number of adhesives 34 may be used to bond the lighting means 26 to the glazing. These adhesives 34 may be provided in the form of a single layer or, alternately, a multi-layer adhesive may be employed to enhance the adherence between components. Two that are commonly used include a moisture cure polyurethane and a two-component catalyzed polyurethane. This adhesive can be made of the same or a different material than that used for bonding the reinforcement 22 to the inner glass layer 202, if any.

Encapsulation is the process by which a plastic assembly is formed and bonded to a glazing. In a typical process, the glazing is placed into a mold and then the mold is filled with a thermoplastic. The plastic may be used to adhere various components to the assembly such as mounting means and spacers to facilitate final assembly of the vehicle.

The lighting means 26 may be temporarily adhered to the glazing by a low tack double backed tape and then permanently embedded in an encapsulation 24.

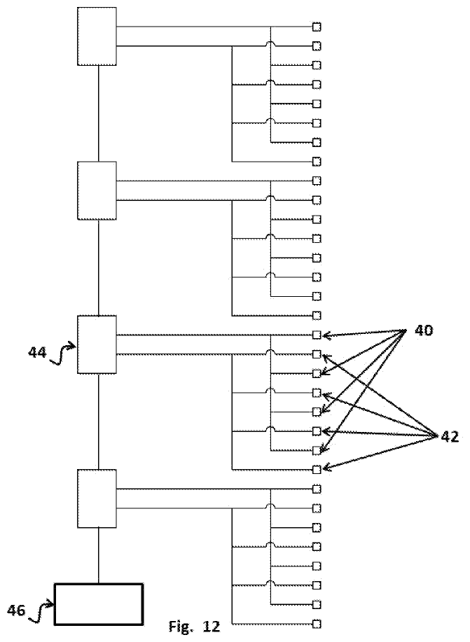

The lighting means 26 may be comprised of at least two independent set of LEDS 28. One such circuit is shown in FIG. 12. The first set 40 serves as the primary set and the second set 42 serves as a backup. In the event of a failure in the primary set 40, the backup set is activated. The primary 40 and backup 42 sets are divided into smaller groups of four LEDs each to improve reliability further. Each group of four can be independently turned on or off by the switching means 44 (control circuit). Detection and switching are accomplished by monitoring the current flow. When a failure is detected, the backup group is automatically switched on and the failed group is switched off. In an alternate embodiment, the LEDs 28 are set such that they can be manually switched by means of an interface 46. The interface 46 may be implemented as simply as a set of switches or a serial communications bus may be utilized to interface 46 the lighting means with a computer.

An option is to use a light detector to measure the output of the LEDs 28 and adjust the groups accordingly. This method is particularly advantageous in that most LEDs will not completely fail but over time their light output will diminish.

The ability to provide a cost-effective LED solution is at least in part enabled by the availability of low-cost, long-life, bright, thin, small, high output LEDs. Another factor is the automated circuit assembly machines now available. Doubling or even tripling the number of LEDs and control circuits does not double or triple the cost of production. The small increase in cost is more than offset by the added benefit of having a lighting means that for all practical purposes will never fail and as such can be embedded and permanently attached to the glazing.

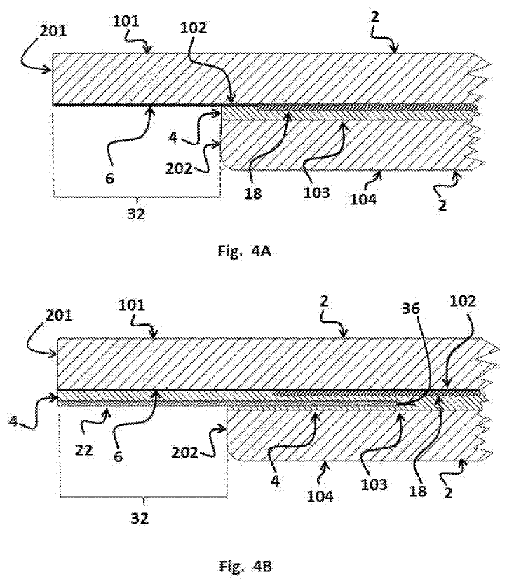

As can be seen from FIG. 4A, the light bar (not shown) is attached to the glazing in the offset portion 32 of the outer glass layer 201. To have a light bar that can be serviced, we first need to keep it out of the path of the adhesive or encapsulation. As a result, the offset 32 in the inner glass layer 202 must be made even wider to allow the light bar to be moved inboard. This further weakens the glazing and is undesirable. By making the light bar a permanent part of the glazing, we only need to have an offset 32 that is slightly wider than the light bar. Another drawback is that partial disassembly of the interior is also required to gain access to the light bar further complicating the design and driving the part count up.

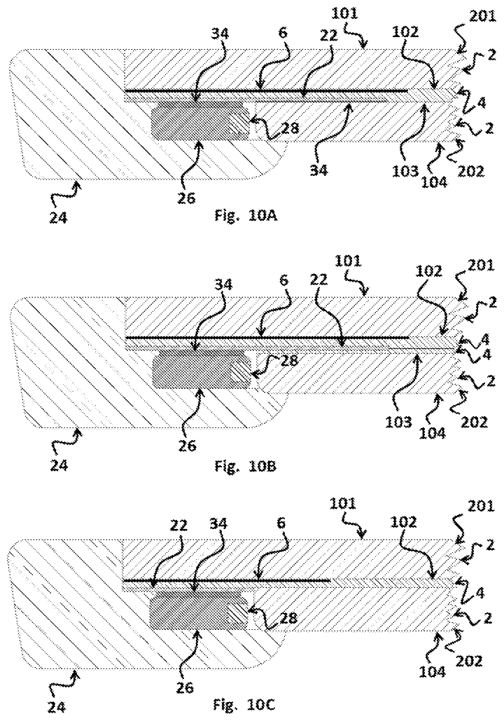

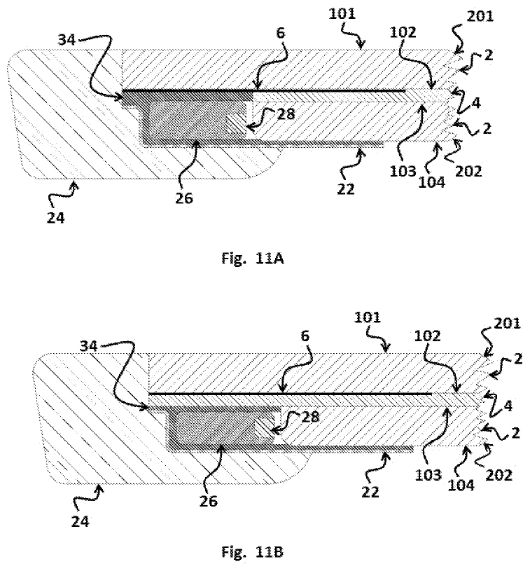

The light bar 26 with redundant LEDs is permanently attached to the glazing and used in conjunction with the reinforcement 22 to overcome both the issue of strength and that of serviceability of the light bar 26. The light bar 26 may be bonded to the glazing over the reinforcement 22 (as shown in FIGS. 10A and 10B). Alternately, the reinforcement 22 may be applied over the light bar 26 provided that the reinforcement 22 is still able to make sufficient contact with the outer 201 and inner 202 glass layers and the adhesive 34 used to bond the light bar 26 to the glass has sufficient adhesion and strength to retain glass chips and hold the broken pieces together in the same manner as the interlayer (as shown in FIGS. 11A and 11B). In fact, the interlayer 4 may be used to bond the light bar 26 to the glazing by allowing the interlayer 4 to extend sufficiently beyond the inboard offset of the inner glass layer 202 edge of glass.

If the reinforcement is positioned between the light bar and the edge of the inner glass layer, the reinforcement may be provided with apertures cut such that the light from each LED is unobstructed.

The reinforcement, while providing the needed added strength does not substantially improve the stiffness of the glazing as the reinforcement must necessarily be comprised of a thin flexible material in most cases. The stiffness of the part, in the area where the two glass layers do not overlap is provided only by the outer glass layer. As a result, undesirable deflection under load can occur, stressing the glass. This is of concern during normal operation as well of in the event of breakage.

In the event of breakage, any remaining stiffness is provided by just the interlocking edges of any remaining glass and support is only provided by the reinforcement and the adhesive bonding the reinforcement to the broken glass. While the glazing may continue to keep the body opening somewhat protected and closed, it will tend to sag under the force of gravity. In the event of an accident, especially a roll-over, this may not be sufficient to maintain retention of the glazing in the body opening.

An outer glass edge encapsulation may provide some improvement in stiffness but in the event of breakage there is no change in performance if the encapsulation does not extend sufficiently inboard of the outer edge of glass and the adhesive bonding the glazing to the body or frame such that the reinforcement is captured and supported.

In this document, components modified or added to the glazing that serve as a stiffening means shall be referred to as a “stiffening support”.

In some embodiments, an additional stiffening support 30 is added so as to add stiffness and support and in doing so also improve retention of the glazing in the opening during use and in the event of breakage.

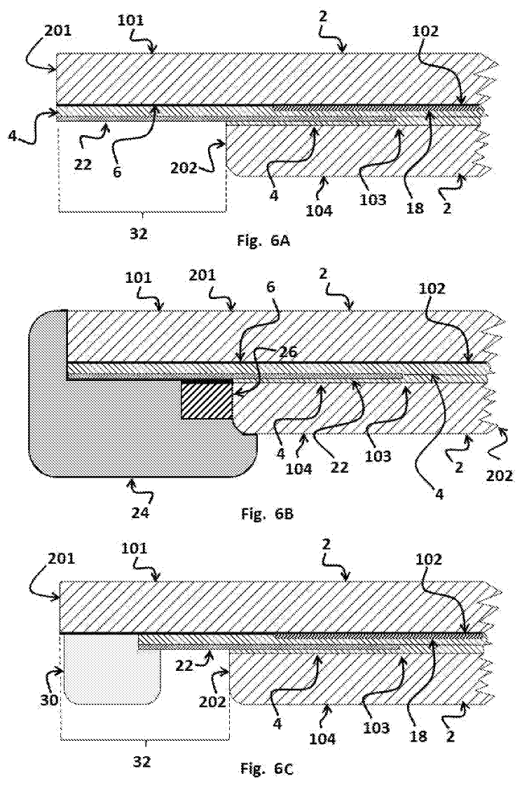

The concept is illustrated in FIG. 6C. The stiffening support 30 in this example is provided by an injection molded encapsulation or by other means such as a polyurethane extruded component capturing both the periphery of the outer glass layer and the reinforcement. The inboard edge of the encapsulation has been extended through the body/glazing adhesive line but stops short of the inner glass layer. This gap, between the encapsulation and the inner edge of glass provides an area where a lighting means (not shown in FIG. 6C) may be mounted. The portions of the periphery where the lighting means are not required may have the stiffening support extended to and overlapping the inner glass layer.

The lighting means may be permanently mounted to the glass in the gap provided by the stiffening support 30 or by a means that is easily reversed providing for replacement and service. An example of an easily reversed mounting means is a hook and loop fabric type of attachment.

Embodiments in which the lighting means is to be permanently installed may have the inboard edge of the stiffening support extended further inboard and have the stiffening support applied over the lighting means.

The stiffening support does not need to extend outboard to the edge of the outer glass layer or even to the glazing/body adhesive path. It needs only to overlap a portion of the reinforcement to provide added stiffness.

If the glazing is provided with an encapsulation or an extruded polymer or other component bonded to the glass the stiffening support 30 may be combined with said component. The inboard edge of the component may be modified such as to provide support in addition to its primary function. The stiffening support 30 may also be provided as a separate component bonded to the glass as shown in FIG. 6C. Multiple supports may be added as needed.

It should be noted that not all materials used for an encapsulation or extruded polymer may be of sufficient stiffness to provide the needed support. In this case, the stiffening support 30 may overlap the encapsulation/extruded polymer.

The stiffening support may overlap the inner glass but does not need too. The reinforcement connects the inner glass to the stiffening support so if the glass breaks or a force is applied, the stiffening support 30 will support the glass still. The stiffening support needs to extend inboard of the body/glazing adhesive to be effective. Otherwise, only the adhesive and the reinforcement provide all of the support. However, the outboard edge of the stiffening support can be inboard of the adhesive.

Any number of materials and processes may be employed to fabricate the stiffening support 30. The ideal material has the highest stiffness while minimizing weight, thickness and cost. In addition to an injection molded plastic, a polyurethane extruded component has been used. The materials that may also be used to fabricate the stiffening support include but are not limited to steel, aluminum, other plastics, carbon fiber, fiberglass or any other material that meets the criteria. When necessary, an adhesive or an adhesive promoter may be used to bond the stiffening support to the glazing. Likewise, any number of process may be used including but not limited to extrusion, direct injection and encapsulation. If the glazing includes an encapsulation, the stiffening support 30 may be integrated with the encapsulation and applied at the same time either as an extension of the original encapsulation or as a separate component. Depending upon the selection of material and design the thickness of the support need not be any different than that of the inner glass layer. By maintaining the same thickness as a standard laminate, the laminate of the invention may be a direct drop-in replacement for a standard glazing.

### Description of Embodiments

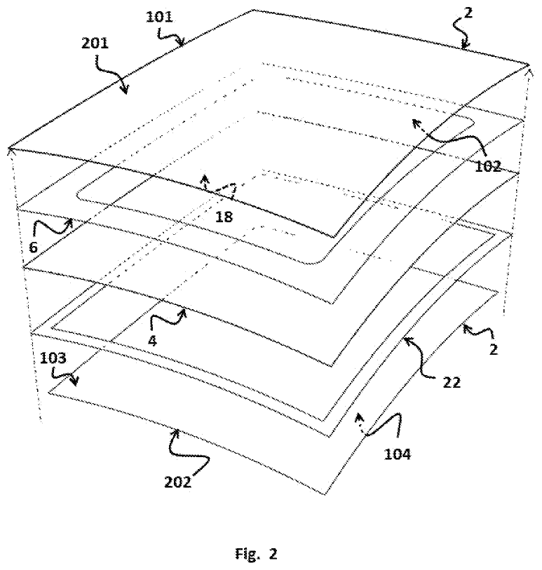

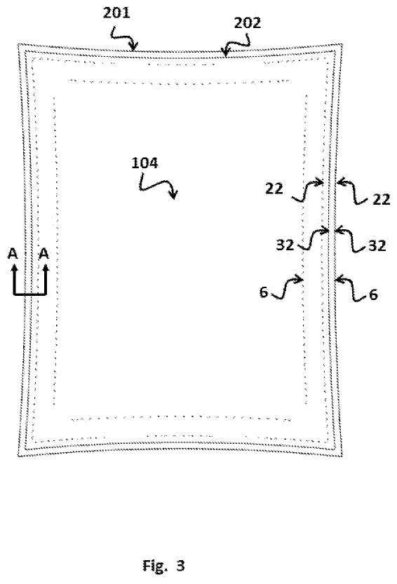

Embodiment 1 is a large laminated panoramic roof illustrated in FIGS. 2 and 3. The outer glass layer 201 is comprised of 2.1 mm thick, clear, soda-lime, annealed glass 2 with a solar control coating 18 and a black band 6 on surface two 102. The black band is screen printed on the cut flat glass. The outer glass with the printed black band is then heated to fire the black frit. Then, the solar coating 18 is applied to surface two 102 by means of a MSVD coater. The inner glass layer 202 is cut so that it is 60 mm smaller than the outer glass layer 201 all around. The two glass layers are then gravity bent to shape.

The laminate is assembled as shown in the exploded view, FIG. 2. The cross section is shown in FIG. 4B. The reinforcement 22 is 70 mm wide. To accommodate the reinforcement 22, the edge of the single sheet of PVB interlayer 4 is slit to a depth of around 10 mm. The reinforcement 22 is inserted in this slit 36. The PVB-reinforcement is sandwiched between the two glass layers 201, 202. Index marks, printed with the black frit, are used to align the two offset 32 layers. The reinforcement 22 is comprised of 0.4 mm thick stainless-steel mesh cloth.

Embodiment 2 is the same as embodiment 1 with the exception of the reinforcement 22. The reinforcement 22 is comprised of 0.2 mm PET, preferably a PET with adhesion promoter on at least one surface.

Embodiment 3 is the same as embodiment 1 with the exception of the reinforcement 22. The reinforcement 22 is comprised of 0.2 mm carbon fiber cloth.

Embodiment 4 is the same as embodiment 1 with the exception of the reinforcement 22. The reinforcement 22 is comprised of at least a 0.2 mm thick chemically tempered aluminosilicate glass.

Embodiment 5 is the same as embodiment 1 with the exception of the reinforcement 22 and that the slit 36 is not made in the edge of the PBV interlayer 4. Rather an 0.76 mm layer of PVB interlayer 4 and a second 0.38 mm thick layer of PVB 4 are used to laminate the reinforcement 22 placed between the two layers of PVB 4 as is also shown in FIG. 6A. The reinforcement 22 is comprised of 0.4 mm fiberglass cloth.

Embodiment 6 is the same as embodiment 5 with the exception of the reinforcement 22. The reinforcement 22 is comprised of 0.4 mm aramid fiber cloth.

Embodiment 7 is the same as embodiment 5 with the exception of the reinforcement 22. The reinforcement 22 is comprised of 0.4 mm thick metal sheet, preferably a stainless-steel sheet or aluminum sheet.

Embodiments 8, 9, 10 and 11 are the same as 1, 2, 3 and 4 with the exception that the slit 36 is not made in the edge of the PBV interlayer 4. Rather an 0.76 mm layer of PVB interlayer 4 and a second 0.38 mm thick layer of PVB 4 are used to laminate the reinforcement 22 placed between the two layers of PVB 4 as is also shown in FIG. 6A.

Embodiments 12, 13 and 14 are the same as 5, 6 and 7 with the exception of the PVB interlayers 4. Rather than using two PVB interlayers 4, three 0.38 mm layers of PVB interlayer are used to laminate the reinforcement placed between two layers of PVB, while the third layer of PVB is used as a compensation layer (not shown).

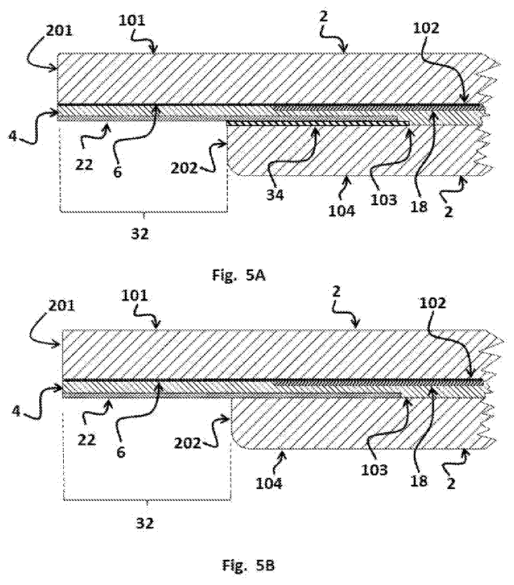

Embodiments 15, 16, 17 and 18 are the same as 1, 2, 3 and 4 with the exception that the slit 36 is not made in the edge of the PBV. Rather an adhesive 34 is used to bond the reinforcement 22 to the inner glass layer 202 as shown in FIG. 5A.

Embodiment 19 is the same as embodiment 1 with the exception of the reinforcement 22 and that the slit 36 is not made in the edge of the PBV. The reinforcement 22 is comprised of 0.18 mm PET or CPET, wherein the reinforcement 22 is bonded directly to the inner glass layer 202 by means of the thermoplastic properties of the PET or CPET material as illustrated in FIG. 5B.

Embodiment 20 is the same as embodiment 5 with the exception of the reinforcement 22. The reinforcement 22 is comprised of 0.18 mm PET, preferably a PET with adhesion promoter on at least one surface.

Embodiment 21 is the same as embodiment 1 with the exception of the reinforcement 22 and that the slit 36 is not made in the edge of the PBV interlayer 4. The reinforcement 22 is comprised of 0.18 mm PET, preferably a PET with adhesion promoter on at least one surface. Likewise, the reinforcement 22 is bonded to the outer glass layer 201 only in that area where the two glass layers 201, 202 do not overlap 32 (similar to the embodiment depicted in FIG. 10C).

Embodiment 22 is the same as any one of the preceding embodiments, wherein the solar control coating 18 is a triple silver solar coating.

Embodiment 23 is the same as any one of embodiments 5 to 14 further comprising a SPD film.

Embodiment 24 is the same as any one of embodiments 5 to 14 further comprising a PDLC film.

Embodiment 25 is the same as any one of embodiments 5 to 14 comprising a sound deadening acoustic interlayer such as an acoustic PVB.

Embodiment 26 is the same as embodiment 22 further comprising a low emissivity (low-e) and anti-reflective coating on surface four 104.

Embodiment 27 is the same as any one of the preceding embodiments with the exception of the outer glass layer 201. The outer glass layer 201 is partially thermally tempered.

Embodiment 28 is the same as any one of embodiments 1 to 26 with the exception of the outer glass layer 201. The outer glass layer 201 is chemically tempered.

Embodiment 29 is the same as any one of embodiments 1 to 26 with the exception of the outer glass layer 201. The outer glass layer 201 is 3.2 mm thick and fully thermally tempered.

Embodiment 30 is the same as any one of the preceding embodiments further comprising a set of light bars 26, bonded to the glazing in the offset reinforced portion of the left and right edges and a light dispersing pattern printed on surface three wherein the light dispersing ink is substantially invisible when the light bars 26 are in the off state.

Embodiment 31, illustrated in FIG. 6B, is the same as embodiment 30 further comprising an injection molded plastic encapsulation 24 wherein at least a portion of the offset reinforced portion of the laminate is embedded in the encapsulation 24.

Embodiment 32 is the same as embodiment 1 with the exception of the inner glass layer 202 and the reinforcement 22. The inner glass layer 202 is cut so that it is at least 10 mm smaller than the outer glass layer 201 all around, and the reinforcement 22 is at least 20 mm wide.

Embodiment 33 is the same as embodiment 1 with the exception of the inner glass layer 202 and the reinforcement 22. The inner glass layer 202 is cut so that it is at most 240 mm smaller than the outer glass layer 201 all around, preferably at most 120 mm. The reinforcement 22 is sized to fit within the area of the outer glass layer 201 where the two glass layers 201, 202 do not overlap 32. Likewise, in some additional embodiments, the reinforcement 22 is also partially incorporating between the two glass layers of the laminate by at least 20 mm, preferably at least 10 mm.

Embodiment 34 is the same as any one of the preceding embodiments with the exception of the outer glass layer 201. The outer glass layer 201 is comprised of 2.5 mm thick, clear, soda-lime, annealed glass.

Embodiment 35 is the same as any one of the embodiments 1 to 34 with the exception of the outer glass layer 201. The outer glass layer 201 is comprised of 3.2 mm thick, clear, soda-lime, annealed glass.

Embodiment 36 is the same as any one of embodiments 1 to 33, but instead of a laminated panoramic roof, embodiment 36 is a laminated movable roof having an outer glass layer 201 which comprises a 2.1 mm thick, clear, soda-lime, semi-tempered glass.

Embodiment 37 is the same as any one of the preceding embodiments, wherein the inner glass layer is no more than 2.1 mm thick, preferably no more than 1.6 mm.

Embodiment 38 is the same as any one of the preceding embodiments, wherein the inner glass layer is an aluminosilicate glass layer having a thickness of no more than 1.2 mm.

In the following embodiments, the lighting means 26 is comprised of two LED light bars which are mounted along the long sides of the glazing by means of an adhesive. Each light bar has a primary 40 and a redundant secondary 42 set of LEDs 28. The primary and secondary LEDs are alternately placed along the length with ˜12 LEDs per 10 cm. Sets of four are wired in series and controlled by a switching means 44 (as shown in FIG. 12). The switching means 44 also performs error detection by monitoring the current in the circuit and reporting errors over a CAN (Controller Area Network) serial communications bus. The control circuit 44 monitors the system and switches the LEDs sets on and off as needed. A serial interface 46 to a computer is also provided by which the state of the LEDs can be viewed, and the automatic switching can be over-ridden. This may be desirable for a set that has diminished in brightness but not to the point where the error detection is triggered.

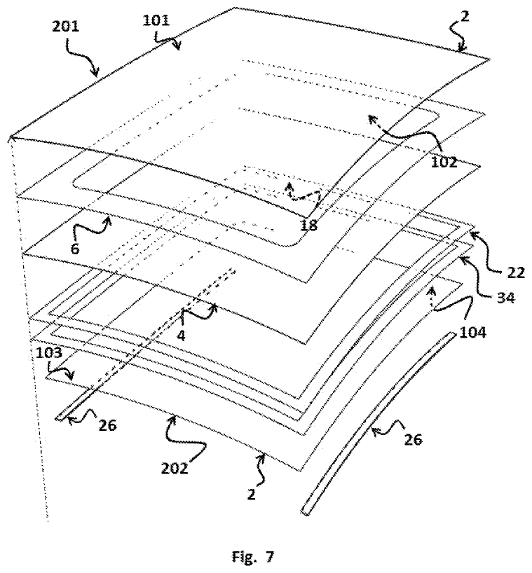

Embodiment 39 is the large laminated panoramic roof illustrated in FIGS. 2, 7 and 10A. The outer glass layer 201 is comprised of 3.15 mm thick, clear, soda-lime, annealed glass 2 with a solar control coating 18 and a black band 6 on surface two 102. The black band 6 is screen printed on the cut flat glass. The outer glass layer 201 with the printed black band is then heated to fire the black frit. Then, a solar coating 18 is applied to surface two 102 by means of a MSVD coater (not shown in FIG. 10A). The inner glass layer 202 is cut so that it is 70 mm smaller than the outer glass layer 201 all around. The two glass layers are then gravity bent to shape. The PVB interlayer 4 extends to the edge of the outer glass layer 201, the reinforcement 22 is bonded to the outer glass layer by means of the PVB. An adhesive 34 is used to bond the reinforcement 22 to the inner glass layer 202. The light bar 26 is bonded to the reinforcement by means of an adhesive 34 (not shown in FIG. 2). The laminate is assembled as shown in the exploded view, FIG. 7. The cross section is shown in FIG. 10A. The reinforcement 22 is 90 mm wide. The reinforcement 22 is thus sandwiched between the two glass layers 201, 202. The reinforcement 22 is comprised of 0.4 mm thick stainless-steel mesh cloth.

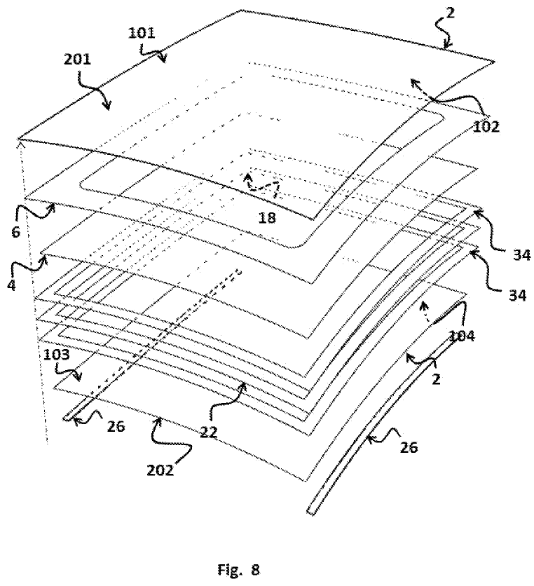

Embodiment 40 is the large laminated panoramic roof illustrated in FIGS. 3 and 8. The outer glass layer 201 is comprised of 2.5 mm thick, clear, soda-lime, annealed glass 2 with a solar control coating 18 and a black band 6 on surface two 102. The black band 6 is screen printed on the cut flat glass. The outer glass layer 201 with the printed black band is then heated to fire the black frit. Then, a solar coating 18 is applied to surface two 102 by means of a MSVD coater. The inner glass layer 202 is cut so that it is 60 mm smaller than the outer glass layer 201 all around. The two glass layers are then gravity bent to shape. The PVB interlayer 4 extends to the edge of the inner glass layer 202, the reinforcement 22 is bonded to the outer glass layer 201 by means of an adhesive 34. An adhesive 34 is used to bond the reinforcement 22 to the inner glass layer 202. The light bar 26 is bonded to the reinforcement 22 by means of an adhesive 34. The laminate is assembled as shown in the exploded view, FIG. 8. The reinforcement 22 is 80 mm wide. The PVB-reinforcement is sandwiched between the two glass layers 201, 202. The reinforcement 22 is comprised of 0.4 mm thick stainless-steel mesh cloth.

Embodiment 41 is the large laminated panoramic roof illustrated in FIGS. 3 and 10B. The outer glass layer 201 is comprised of 2.1 mm thick, clear, soda-lime, annealed glass 2 with a solar control coating 18 and a black band 6 on surface two 102. The black band 6 is screen printed on the cut flat glass. The outer glass layer 201 with the printed black band is then heated to fire the black frit. Then, a solar coating (not shown) is applied to surface two 102 by means of a MSVD coater. The inner glass layer 202 is cut so that it is 60 mm smaller than the outer glass layer 201 all around. The two glass layers are then gravity bent to shape. Two layers of PVB are used. The first PVB interlayer 4 extends to the edge of the outer glass layer 201 and the second PVB layer 4 extends to the edge of the inner glass layer 202. The reinforcement 22 is bonded to the outer glass layer 201 by means of the first PVB interlayer 4. The inboard edge of the reinforcement 22, which overlaps the inner glass layer 202 is placed between the two layers of PVB interlayer 4. The light bar 26 is bonded to the reinforcement 22 by means of an adhesive 34. The cross section is shown in FIG. 10B. The reinforcement 22 is 70 mm wide. The reinforcement 22 is thus sandwiched between the two PVB interlayers 4 and glass layers 201, 202. The reinforcement 22 is comprised of 0.4 mm thick stainless-steel mesh cloth.

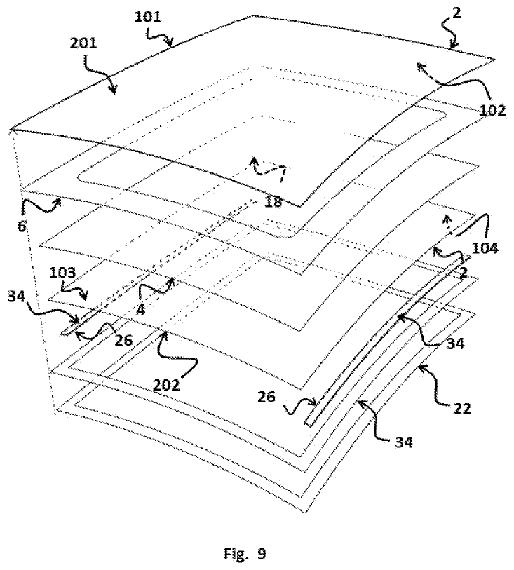

Embodiment 42 is the large laminated panoramic roof illustrated in FIGS. 3, 9 and 11A. The outer glass layer 201 is comprised of 2.5 mm thick, clear, soda-lime, annealed glass 2 with a solar control coating 18 and a black band 6 on surface two 102. The black band 6 is screen printed on the cut flat glass. The outer glass layer 201 with the printed black band is then heated to fire the black frit. Then, a solar coating 18 is applied to surface two 102 by means of a MSVD coater (not shown in FIG. 11A). The inner glass layer 202 is cut so that it is 22 mm smaller than the outer glass layer 201 all around. The two glass layers 201, 202 are then gravity bent to shape. The PVB interlayer 4 extends to the edge of the inner glass layer 202. The light bar 26 is bonded to the exposed outer glass layer 201 by means of an adhesive 34. The reinforcement 22 is bonded to the outer 201 and inner 202 glass layer and to the light bar 26 by means of and adhesive 34. The reinforcement 22 is 40 mm wide. The reinforcement 22 covers the light bar 26 and is bonded to the number two 102 and number four 104 surface. The reinforcement 22 is comprised of 0.4 mm thick stainless-steel mesh cloth. The cross section is shown in FIG. 11A.

Embodiment 43 is the large laminated panoramic roof illustrated in FIGS. 3, 9 and 11B. The outer glass layer 201 is comprised of 2.1 mm thick, clear, soda-lime, annealed glass 2 with a solar control coating 18 and a black band 6 on surface two 102. The black band 6 is screen printed on the cut flat glass. The outer glass layer 201 with the printed black is then heated to fire the black frit. Then, a solar coating 18 is applied to surface two 102 by means of a MSVD coater (not shown in FIG. 11B). The inner glass layer 202 is cut so that it is 22 mm smaller than the outer glass layer 201 all around. The two glass layers 201, 202 are then gravity bent to shape. The PVB interlayer 4 extends to the edge of the outer glass layer 201. The light bar 26 is bonded to the exposed PVB interlayer 4 by means of an adhesive 34. The reinforcement 22 is bonded to the exposed PVB interlayer 4, the inner glass layer 202 and to the light bar 26 by means of an adhesive 34. The reinforcement 22 is 40 mm wide. The reinforcement 22 covers the light bar 26 and is bonded to the number four surface 104. The reinforcement 22 is comprised of 0.4 mm thick stainless-steel mesh cloth. The cross section is shown in FIG. 11B.

Embodiments 44 to 48 are the same as embodiments 39 to 43 with the exception of the reinforcement. The reinforcement 22 is comprised of 0.18 mm PET, preferably a PET with adhesion promoter on at least one surface.

Embodiments 49 to 53 are the same as embodiments 39 to 43 with the exception of the reinforcement. The reinforcement 22 is comprised of 0.2 mm carbon fiber cloth.

Embodiments 54 to 58 are the same as embodiments 39 to 43 with the exception of the reinforcement. The reinforcement 22 is comprised of at least a 0.2 mm thick chemically tempered aluminosilicate glass.

Embodiments 59 to 63 are the same as embodiments 39 to 43 with the exception of the reinforcement and the PVB interlayer 4. The reinforcement 22 is comprised of 0.4 mm fiberglass cloth, while instead of having a PVB interlayer, there is at least two PVB interlayers.

Embodiments 64 to 68 are the same as embodiments 59 to 63 with the exception of the reinforcement. The reinforcement 22 is comprised of 0.4 mm aramid fiber cloth.

Embodiments 69 to 73 are the same as embodiments 59 to 63 with the exception of the reinforcement. The reinforcement 22 is comprised of 0.4 mm thick metal sheet, preferably a stainless-steel sheet or aluminum sheet.

Embodiment 74 is the same as any one of the embodiments 39 to 73, wherein the solar control coating 18 is a triple silver solar coating.

Embodiment 75 is the same as any one of the embodiments 59 to 73 further comprising an SPD film.

Embodiment 76 is the same as any one of the embodiments 59 to 73 further comprising a PDLC film.

Embodiment 77 is the same as any one of the embodiments 59 to 73 further comprising a sound deadening acoustic interlayer such as an acoustic PVB.

Embodiment 78 is the same as embodiment 74 further comprising a low-e and anti-reflective coating on surface four 104.

Embodiment 79 is the same as any one of embodiments 39 to 78 wherein the set of light bars 26 are bonded to the glazing in the offset reinforced portion of the left and right edges and a light dispersing pattern printed on surface three 103 wherein the light dispersing ink is substantially invisible when the light bars 26 are in the off state.

Embodiment 80 is the same as any one of embodiments 39 to 79 further comprising an injection molded plastic encapsulation 24 wherein at least part of the offset reinforced portion of the laminate is embedded in the encapsulation 24.

Embodiment 81 is the same as any one of embodiments 39 to 80 with the exception of the outer glass layer. The outer glass layer is partially thermally tempered.

Embodiment 82 is the same as any one of embodiments 39 to 80 with the exception of the outer glass layer. The outer glass layer is chemically tempered.

Embodiment 83 is the same as any one of embodiments 39 to 80 with the exception of the outer glass layer. The outer glass layer is 3.2 mm thick and fully thermally tempered.

Embodiment 84 is the same as any one of previous embodiments further comprising a set of ribbed supports fabricated by extrusion of polyurethane, having a wall thickness of 3 mm and extending from the midpoint of the glazing/body adhesive line to 12 mm outboard of the inner edge of glass. The supports are bonded to the glazing by means of a two-component adhesive after lamination.

Furthermore, in some embodiments, the inner glass layer 202 is cut so that it is at most 240 mm smaller than the outer glass layer 201 all around, preferably at most 120 mm.

As can be appreciated, further embodiments may be created by means of a full factorial of the many features described and claimed for the invention. All possible combinations are not enumerated but anyone may be derived from the specification set forth within.

### REFERENCE NUMERALS OF DRAWINGS

2 Glass

4 Bonding/Adhesive Layer (interlayer)

6 Obscuration/Black Frit

12 Film

18 Coating

22 Reinforcement

24 Encapsulation

26 Lighting Means

28 LED

30 Stiffening support

32 Edge Offset

34 Adhesive

36 Slit in interlayer

40 LED SET 1

42 LED SET 2

44 Control

46 Interface 101 Surface one

102 Surface two

103 Surface three

104 Surface four

201 Outer layer

202 Inner layer

1. An automotive laminated comprising:
an outer glass layer (201);
an inner glass layer (202), wherein the edge of the inner glass layer (202) is offset inboard from the edge of the outer glass layer (201) along at least a substantial portion of the periphery of the laminate;
at least one plastic bonding layer (4) placed between outer (201) and inner (202) glass layers; and
a reinforcement layer (22) having at least one portion, a first portion, which is bonded to at least a substantial portion of the outer glass layer in that area where the two glass layers do not overlap (32);
wherein the outer glass layer (201) is thicker than the inner glass layer (202); and
wherein the first portion of the reinforcement layer (22) is configured to connect direct or indirectly the laminate to the mounting means.

2. The automotive laminate according to claim 1, wherein the reinforcement layer (22) comprises two portions, the first portion and a second portion; wherein the second portion is bonded to the inner glass layer (202).

3. The automotive laminate according to claim 2, wherein the second portion of the reinforcement layer (22) is laminated between the two glass layers (201, 202).

4. The automotive laminate according to any one of the preceding claims, wherein the reinforcement layer (22) is comprised of at least one of the materials selected from the group of: metal sheet, PET, polycarbonate, polyimide, polyamide, fiberglass cloth, and carbon fiber.

5. The automotive laminate according to any one of the claims 1 to 3, wherein the reinforcement layer (22) is comprised of at least one of the materials selected from the group of: metal mesh, CPET, PET with adhesion promoter in at least one surface and aramid cloth.

6. The automotive laminate according to any one of the preceding claims, wherein the reinforcement layer (22) is a chemically tempered aluminosilicate glass.

7. The automotive laminate according to any one of the preceding claims, wherein the reinforcement layer (22) has a thickness of no more than 0.7 mm.

8. The automotive laminate according to any one of the claims 1 to 6, wherein the reinforcement layer (22) has a thickness of less than 0.5 mm.

9. The automotive laminate according to any one of the preceding claims, wherein the outer glass layer (201) is fully tempered or semi-tempered having a thickness of no more than 4.85 mm, preferably no more than 3.85 mm, more preferably no more than 3.2 mm, even more preferably no more than 2.85 mm.

10. The automotive laminate according to any one of the claims 1 to 8, wherein the outer glass layer (201) is annealed glass having a thickness of no more than 3.5 mm, preferably no more than 2.5 mm, more preferably no more than 2.1 mm.

11. The automotive laminate according to any one of the preceding claims, wherein the inner glass layer (202) has a thickness of no more than 3.2 mm, preferably no more than 2.1 mm, more preferably no more than 1.6 mm.

12. The automotive laminate according to any one of the claims 1 to 10, wherein the inner glass layer (202) has a thickness no more than 1.1 mm, preferably no more than 0.7 mm.

13. The automotive laminate according to claim 12, wherein the inner glass layer (202) is cold bent.

14. The automotive laminate according to any one of the preceding claims, wherein the inner glass layer (202) is chemically tempered.

15. The automotive laminate according to any one of the preceding claims, wherein the offset (32) of the edge of the inner glass layer (202) from the edge of the outer glass layer (201) is at least 10 mm.

16. The automotive laminate according to any one of the preceding claims, wherein the edge of the inner glass layer (202) is offset inboard from the edge of the outer glass layer (201) along the left and right side of the periphery of the laminate.

17. The automotive laminate according to any one of the claims 1 to 15, wherein the edge of the inner glass layer (202) is offset inboard from the edge of the outer glass layer (201) along the entire periphery of the laminate.

18. The automotive laminate according to any one of the preceding claims, wherein the first portion of the reinforcement layer (22) is bonded to the entire portion of the outer glass layer (201) in that area where the two glass layers do not overlap (32).

19. The automotive laminate according to any one of the preceding claims, further comprising at least one coating with solar control properties on the interior surface selected from the group consisting of a low-e coating and an anti-reflective coating.

20. The automotive laminate according to any one of the preceding claims further comprising a variable light transmittance film.

21. The automotive laminate according to any one of the preceding claims, wherein at least a portion of the area where the two glass layers do not overlap (32) is embedded in an injection molded plastic encapsulation (24).

22. The automotive laminate according to any one of the preceding claims, wherein the reinforcement layer (22) is bonded to the inner glass layer (202) by means of an adhesive (34).

23. The automotive laminate according to any one of the preceding claims, further comprising light dispersing means.

24. The automotive laminate according to claim 21, wherein the lighting means (26) comprises a set of light bars (28) bonded to the laminate in the area where the two glass layers do not overlap (32), and wherein the light dispersing means is printed on a surface of the inner glass layer (202).

25. The automotive laminate according to any one of the preceding claims, wherein the lighting means (26) comprises at least two independent set of light sources, a primary set of light sources (40) and a redundant secondary set of light sources (42), wherein the first set (40) is configured to serve as the primary set and initial light source and the redundant secondary set (42) is configured to serve as a backup light source.

26. The automotive laminate according to any one of the claims 23 to 25, wherein the lighting means (26) is bonded to first portion of the reinforcement layer (22) by means of an adhesive (34).

27. The automotive laminate according to any one of the claims 23 to 26, wherein the lighting means (26) is permanently attached and encapsulated to the glazing.

28. The automotive laminate according to any one of the claims 23 to 27, wherein the lighting means (26) is disposed between the outer glass layer (201) and the reinforcement layer (22).

29. The automotive laminate according to any one of the preceding claims, wherein the automotive laminate is a panoramic roof.

30. The automotive laminate according to any one of the claims 1 to 28, wherein the automotive laminate is a movable roof.

31. The automotive laminate according to any one of the preceding claims, further comprising a stiffening support (30) applied to at least a portion of the outer glass layer (201) and extending sufficiently inboard such as to capture at least a portion of the reinforcement layer (22) improving resistance to deflection and retention of the glazing.
